(19) United States
(12) Patent Application Publication
(10) Pub. No.: US 2025/0155059 A1
(43) Pub. Date: May 15, 2025

(54) FIXATION MECHANISM FOR HIGH TEMPERATURE SEALS OF TUBES

(71) Applicant: Honeywell International Inc., Charlotte, NC (US)

(72) Inventors: Jason Smoke, Phoenix, AZ (US); Mehrad Mehr, Morristown, NJ (US)

(21) Appl. No.: 18/506,702

(22) Filed: Nov. 10, 2023

(51) Int. Cl. F16L 23/036; F16L 23/024; F16L 23/032; F16L 23/16; F16L 23/24

(52) U.S. Cl. CPC F16L 23/036; F16L 23/032; F16L 23/24; F16L 23/024; F16L 23/162

(57) ABSTRACT

An assembly comprising: a first tube defining a first surface; a second tube defining a second surface, wherein the second surface is configured to contact the first surface at an interface; a fixation mechanism comprising: a first split flange disposed around the first tube; a second split flange disposed around the second tube; and one or more springs coupled to the first split flange and the second split flange, wherein the one or more springs are configured to transfer a relative force between the first tube and the second tube and towards the interface, and wherein the second split flange is configured to be disposed between the interface and the one or more springs.

### GOVERNMENT INTEREST

This invention was made with Government support under 80MSFC21CA010 awarded by NASA. The Government has certain rights in the invention.

### TECHNICAL FIELD

The present disclosure relates generally to high temperature reactor systems, such as systems having at least two different types of pipes or tubes.

### BACKGROUND

Tubes or pipes are used to transport fluids through high-temperature systems such as high temperature reactors. Some systems include different types of tubes, which may include different materials of construction. Joining different types of tubes may be challenging, since the different materials of construction may have different material properties.

### SUMMARY

In general, the disclosure describes systems, such as high-temperature reactor systems, jet or rocket engines, or other similar high temperature systems, which include at least two different types of tubes. The different types of tubes may have different coefficients of thermal expansion (CTE). As such, a seal at an interface between different types of tubes may experience changes in and/or movement of one or more of the different types of tubes, e.g., due to the tendency of the tubes to expand and contract at different rates during temperature changes, which may lead to fluid leakage through gaps that form between sealing surfaces and/or cracked components. A fixation mechanism may be secured around the interface between the different types of tubes, e.g., to maintain the seal between the different types of tubes. The fixation mechanism may apply forces on the different tubes to cause the tubes to form a seal at the interface. For example, a first split flange of the fixation mechanism may apply a first force on a first tube and a second split flange of the fixation mechanism may apply a second force on a second tube to cause the first tube and the second tube to form a seal at an interface disposed between the first and second split flanges of the fixation mechanism. The fixation mechanism may include one or more springs which may cause the fixation mechanism to expand or contract in response to expansion and contraction of the tubes, e.g., to maintain the seal between the tubes.

The devices, systems, and methods described herein may provide several benefits over other fixation assemblies. The fixation mechanism described herein may evenly distribute forces around the outer perimeter of the fixation mechanism, e.g., to facilitate formation of a uniform seal around the outer perimeter of the tubes. The fixation mechanism may further facilitate, e.g., via the one or more springs, relative movement between the different tubes, e.g., to account for the effects of the different rates of thermal expansion without compromising the seal between the tubes. The one or more springs may also permit movement of elements of the fixation mechanism in response to expansion and contraction of the different tubes, which may facilitate maintenance of the seal and reduce stress experienced by the tubes or the elements of the fixation mechanism.

In some examples, this disclosure describes an assembly comprising: a first tube defining a first surface at a first end of the first tube; a second tube defining a second surface at a second end of the second tube, wherein the second surface of the second tube is configured to contact the first surface of the first tube at an interface, and wherein the first tube and the second tube define different coefficients of thermal expansion (CTE); a fixation mechanism configured to be disposed around the first tube and the second tube at the interface, the fixation mechanism comprising: a first split flange disposed around the first tube; a second split flange disposed around the second tube; and one or more springs coupled to the first split flange and the second split flange, wherein the first tube and the second tube define a longitudinal axis extending through the interface, wherein the one or more springs are configured to transfer a relative force between the first tube and the second tube and towards the interface, and wherein the second split flange is configured to be disposed longitudinally between the interface and the one or more springs.

In some examples, this disclosure describes a method comprising: placing a first surface at a first end of a first tube into contact with a second surface at a second end of a second tube at an interface, wherein the first tube and the second tube define different coefficients of thermal expansion (CTE), and wherein when the first surface contacts the second surface, the first tube and the second tube define a longitudinal axis extending through the interface; affixing a first split flange of a fixation mechanism around the first tube at or around the interface; affixing a second split flange of the fixation mechanism around the second tube at or around the interface; advancing one or more elongated bodies through the first split flange and the second split flange to connect the first split flange to the second split flange; and disposing one or more springs over the one or more elongated bodies, wherein the second split flange is longitudinally between the interface and the one or more springs, and wherein the one or more springs are configured to transfer a relative force between the first tube and the second tube and towards the interface.

In some examples, this disclosure describes a fixation mechanism comprising: a first split flange configured to be disposed around a first end of a first tube at or around an interface between the first tube and a second tube; a second split flange configured to be disposed around a second end of the second tube at or around the interface, wherein the second end of the second tube contacts the first end of the first tube at the interface; two or more elongated bodies extending through the first split flange and the second split flange parallel to a longitudinal axis of the fixation mechanism, wherein the two or more elongated bodies are configured to connect the first split flange to the second split flange, and two or more springs, each spring of the two or more springs being disposed around a respective elongated body of the two or more elongated bodies, wherein the two or more springs are configured to transfer a relative force between the first tube and the second tube and towards the interface, wherein the second split flange is configured to be disposed longitudinally between the first split flange and the two or more springs, and wherein the first tube and the second tube define different coefficients of thermal expansion (CTE).

The details of one or more examples are set forth in the accompanying drawings and the description below, where like symbols indicate like elements. Other features, objects, and advantages will be apparent from the description and drawings, and from the claims.

### BRIEF DESCRIPTION OF DRAWINGS

FIG. 1 is a conceptual diagram illustrating an example tube assembly according to some examples the present disclosure.

FIG. 2 is a conceptual diagram illustrating a side view of the example tube assembly of FIG. 1.

FIG. 3A is a conceptual diagram illustrating a side view of an example first sub-section of an example first split flange of the example fixation mechanism of FIG. 2, with some internal features illustrated in broken lines.

FIG. 3B is a conceptual diagram illustrating a top view of the example first sub-section of FIG. 3A.

FIG. 4A is a conceptual diagram illustrating an exploded top view of the example split flange of the example fixation mechanism of FIG. 2.

FIG. 4B is a conceptual diagram illustrating a top view of the example split flange of the example fixation mechanism of FIG. 2 when assembled.

FIG. 5 is a cross-section diagram illustrating a cross-sectional view of the example tube assembly of FIG. 2, the cross-section being taken along line A-A of FIG. 2.

FIG. 6 is a cross-sectional diagram illustrating another cross-sectional view of the example tube assembly of FIG. 2, the cross-section being taken along line A-A of FIG. 2 and along a direction orthogonal to the direction of view illustrated by line A-A.

FIG. 7A is a conceptual diagram illustrating an exploded side view of an example elongated body and spring of the example fixation mechanism of FIG. 2.

FIG. 7B is a conceptual diagram illustrating an exploded side view of an example elongated body and another example spring of the example fixation mechanism of FIG. 2.

FIG. 8 is a conceptual diagram illustrating a side view of another example of the fixation mechanism of FIG. 2.

FIG. 9 is a flow chart illustrating an example process of assembling the example tube assembly of FIG. 1.

### DETAILED DESCRIPTION

High temperature reactors and other high temperature systems may include tubes for transporting fluids. Such systems may include at least two different types of tubes, such as, for example, a ceramic tube and a metal or metal alloy tube. Ceramic tubes may be used in high temperature systems due to the strength and stiffness of the material at high temperatures. Ceramic tubes may also be used due to the excellent thermal shock resistance of the material due to a low coefficient of thermal expansion (CTE), the inherent material property that dictates the rate at which a material expands with increase in temperature. Metal or metal alloy tubes may be used on high temperature system for various reasons, including compatibility with low temperature plumbing, allowing for the use of bellow, or other sealing and flow requirements.

Ceramic tubes, such as tubes made of thermal shock resistant ceramic material, may have a low CTE, such as on the order of about 2-6 parts per million per degree Celsius (ppm/° C.). Ceramic materials may therefore be attractive for hot zones that have temperature gradients or transients. Metal or metal alloy tubes may have a higher CTE, such as on the order of 10-17 ppm/° C. Joining tubes with differing CTEs, such as a ceramic tube to a metal tube, may present problems in areas which are exposed to high temperatures and/or temperature swings, because the tubes may expand and contract differently (e.g., different thermal displacements, different rates of expansion or contraction) in response to changes in temperature. The differing displacements and rates of expansion and contraction during temperature cycles may result in deleterious effects, such as cracked tubes or joint components, and/or gaps between sealing surfaces that allow leaks. Fittings for coupling tubes, such as full couplings, half couplings, reducing couplings, compression couplings, and slip couplings, may not work in these applications, because the differing CTEs of the tubes may result in increased displacement between sealing surfaces that creates leaks, increased forces between tubes and/or fittings that creates cracks, increased stress built up in the tubes or fittings, especially after repeated thermal cycles, that creates material fatigue, or other problems associated with a change in forces at an interface between tubes and/or fittings. Some systems try to avoid or minimize the difficulty in joining tubes with different CTEs by using only one type of tube in areas of the system that are subject to high temperatures. However, this solution may use extra material and dedicate extra space, which may be at a premium, to piping systems, or require additional cooling.

Disclosed herein are assemblies, systems, and techniques for joining tubes that having different CTEs that may be space-efficient and/or robust. The disclosed joining assemblies may be useful in high temperature systems such as high temperature reactors (e.g., methane pyrolysis reactors), or other systems which operate in high temperatures or pipe high-temperature fluids. In some examples, these systems may operate above about 315° C., such as above about 425° C. Polymeric or elastomeric sealing may not be an option in such high temperature systems, because the high temperature that the system may be configured to operate at would melt or otherwise break down such sealing materials. Joining systems according to the present disclosure may allow for joining tubes with different CTEs, such as ceramic tubes and metallic tubes, to be joined in these high-temperature areas, and allow for robust and reliable gas-tight (e.g., gas-tight or nearly gas-tight) sealing performance over a series of cycles between low and high temperatures.

Joining assemblies according to the present disclosure are advantageous in high-temperature applications in aerospace, oil and gas, performance materials, and other industries. Ceramic pipes are being integrated into more industrial applications due to their high temperature capabilities, and transitioning ceramic pipes to metal or metal alloy pipes may be an advantageous enabling technology for incorporating high-temperature components into industrial systems.

In some examples, joining assemblies according to the present disclosure may include a first tube and a second tube. The ends of each tube may define a smooth, planar surface. The smooth, planar surfaces at the ends of the tubes may be placed into contact and forced together via application of force by a fixation mechanism disposed around the ends of the tubes to form a substantially hermetic seal at an interface between the tubes without additional sealing components at the interface, such as gaskets. In some examples, the ends of each tube may define surfaces with other shapes (e.g., a conical shape). Although primarily described as being defined by respective flanges disposed at respective ends of the first tube and second tube, it is also considered that the body of the tube may define the smooth, planar surface, in examples where the tube wall thickness is sufficient to reduce or eliminate paths for fluids contained within the tubes to escape the tubes at the interface. In some examples, the fixation mechanism may accommodate thermal expansion and contraction of one or more tubes in an axial direction and/or a radial direction to facilitate maintenance of a substantially hermetic seal at the interface. The fixation mechanism may be configured to apply a force substantially normal to the first and second smooth, planar surfaces (e.g., a compressive force) while allowing for radial expansion and contraction of the first and/or the second tube in the area of the interface.

In some examples, the assembly may be formed by contacting the first smooth, planar surface (“first surface”) of a first end of the first tube with the second smooth, planar surface (“second surface”) of a second end of the second tube. A fixation mechanism may apply a force substantially normal to the first and second surfaces to drive the first and second surfaces to contact at an interface. The fixation mechanism may apply the force via one or more springs of the fixation mechanism. The contact between the first and second surfaces is intimate enough to substantially close all flow paths, such that fluid flowing through the interface from the first tube to the second tube or vice versa does not leak out of the tubes, even after cycling at relatively high temperature and/or pressure (e.g., at least about 400 degrees Celsius and a pressure of 30 pounds per square inch (psi)). In fact, the disclosed assemblies may operate at very high temperatures, such as greater than about 800 degrees Celsius, or greater than about 1200 degrees Celsius, or up to about 2,000 degrees Celsius, in cases where both the first tube and the second tube include ceramic materials and the force mechanism also includes ceramic materials. In some examples, the disclosed assemblies may be used to join dissimilar ceramic or refractory metal tubes in a hot zone of a high temperature system. In some examples, the disclosed assemblies may be configured to accommodate the differing rates and magnitudes of thermal expansion and contraction of tubes having differing CTEs without breaking the intimate contact between the first and second surfaces, such that the joint remains hermetically sealed throughout the thermal cycle.

The smoothness of the first surface and the second surface may allow for intimate contact between the smooth, planar surfaces at the interface to close any leak paths for fluid flowing within the first tube and or the second tube to escape at the interface. In some examples, the first surface, the second surface, or both may be optically flat. An optically flat surface may have profile height deviations that deviate, on average, on the order of tens of nanometers from a mean line defined by the surface. Surface roughness, as defined herein, is the average distance that profile height variations deviate from a mean line. However, advantageously, the first and second surfaces need not be optically flat for the seal formed to be substantially hermetic. Rather, in some examples, the first surface, the second surface, or both, may define a surface roughness of less than about 1 micrometer, or from about 1 micrometer to about 5 micrometers. Advantageously, allowing for surface roughness from about 1 micrometer to about 5 micrometers may improve manufacturability of the joints, and allow for the use of such joints in more applications.

In some examples, the first tube comprises a flange at the end of the first tube defining the first surface. The flange may define a radial cross-sectional surface that has a greater area than a radial cross-sectional area defined by a body portion of the first tube. For example, the flange may define an outer perimeter that is larger than an outer perimeter defined by a body of the first tube. Inclusion of a flange at an end of the first tube and/or the second tube which define the respective first and second surfaces may be advantageous because the flange may increase the distance that fluid must flow through a leak path to escape the interface, increasing the chances that a leak path may be closed by intimate contact between the first surface and second surface, even when the first surface and second surface are not optically flat. For example, the surface roughness of the first and second surface may define a plurality of tortuous fluid leak paths beginning at the inner diameter of the tube which fluid can travel in a radial direction from inside the interface towards the outer surroundings of the interface, but the plurality of gas leak paths which fluidically connect an inner lumen passing through the interface to the outer surroundings may be substantially eliminated by inclusion of a flange at the end of the first tube, because most or all of the tortuous leak paths will be closed at some point between the inner lumen and the outer surroundings.

The fixation mechanism may include a first split flange and a second split flange configured to apply a force on the first tube and the second tube, respectively. Each of the first and second split flanges may be configured to interface with a flange of a respective tube. For example, the first split flange may contact and apply a force on the flange of the first tube and the second split flange may contact and apply a force on the flange of the second tube. The first and second split flanges may be coupled to the one or more springs of the fixation mechanism. The one or more springs may transmit spring forces to the first and second split flanges, e.g., to apply forces on the first and second tubes at or around the interface. The first and second split flanges may extend substantially around the outer perimeter of the respective tubes, e.g., to facilitate even application of force around the outer perimeter of the interface, thereby facilitating substantially even contact between the first and second tubes around the outer perimeter of the interface.

The planarity, which may also be called flatness, of the first and second surfaces may also allow for intimate contact between the first and second surfaces. A perfectly planar surface is straight in two directions. Planarity, in some examples, refers to a maximum distance between two planes defined by the surface. In examples where the first surface and second surface are planar surfaces, intimate contact may be maintained from the inner diameter to the outer diameter of the joint without excessive force from the force mechanism, which may reduce leakage out of the joint. In some examples, the first surface, the second surface or both may define a planarity of less than 20 micrometers, such as less than 10 micrometers, or less than 1 micrometer. Use of planar surfaces, rather than surfaces that are warped (e.g., bowed) may advantageously reduce the force necessary to maintain intimate contact between the first surface and the second surface.

The fixation mechanisms described herein may be configured to maintain intimate contact between materials having differing thermal properties. The first tube may define a first coefficient of thermal expansion (CTE). For example, the first tube may include a ceramic material, and the first CTE may be from about 2 parts per million per degree Celsius (ppm/° C.) to about 6 ppm/° C. In some examples, the second tube may define a second CTE. For example, the second tube may include a metallic material such as a metal or alloy having a higher CTE than the material of the first tube, such as from about 10 ppm/° C. to about 17 ppm/° C. As such, the second tube may have a different CTE than the first tube, such as at least 4 ppm/° C. different than the first CTE. As the assembly is cycled through different temperatures, the intimate contact necessary to seal fluids flowing through the assembly may be maintained at the interface between the first and second surfaces while the interface is configured to accommodate radial and/or axial thermal expansion and contraction so that the different CTE materials do not cause either tube to break or fracture.

In some examples, a tube assembly of the first tube, the second tube, and the fixation mechanism may be configured to reduce or prevent plastic deformation at the sealing interface to remain gas-tight during continuous or intermittent temperature cycling. Parameters to ensure the assembly forms and holds a seal may include geometric factors (e.g., thickness, diameter, and other geometric ratios), material factors, (e.g., elastic modulus of the materials, yield stress of the materials, temperature dependence of the CTE of the materials), manufacturing parameters, (work hardening during sealing), and other factors that may affect displacement of surfaces or generation of stresses in the joining assemblies. Since the assembly is configured to contain fluids passing through the first and second tubes, tight machining tolerances may also be desirable. Tubes, with or without flanges, of the present disclosure may be manufactured using any suitable technique, including but not limited to subtractive processes such as machining or grinding, additive processes such as additive manufacturing, or mixtures or combinations thereof.

Although described herein primarily with respect to an example tube assembly joining a ceramic tube to a metal tube, it is considered that assemblies described herein may be useful for other material systems, including tube assemblies that join two tubes having the same or similar CTEs or that include two materials with different CTEs. For example, two metallic (e.g., metal or metallic alloy) tubes could be joined using an assembly in accordance with the present disclosure. In some examples, the metallic tubes could be the same material, and thus have the same CTE. In some examples, the tubes may be constructed of two different types of metals, and thus have different CTEs.

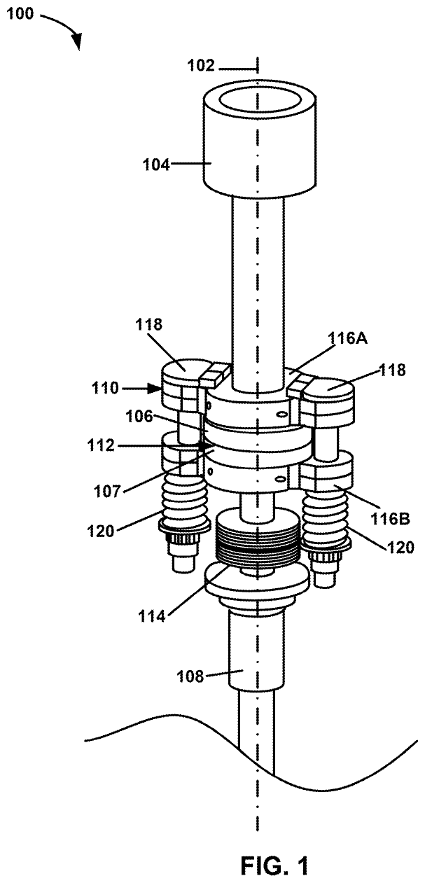

FIG. 1 is a conceptual diagram illustrating an example tube assembly 100. Tube assembly 100 may include a first tube 104, a second tube 108, and a fixation mechanism 110. First tube 104 and second tube 108 may be circumferentially aligned relative to a longitudinal axis 102 extending through first tube 104, second tube 108, and fixation mechanism 110. First tube 104 and second tube 108 may be placed into contact and form a substantially hermetic seal at an interface 112. Fixation mechanism 110 may apply forces on first tube 104 and second tube 108 to maintain the seal at interface 112.

First tube 104 may extend along longitudinal axis 102 to a first end at interface 112. In some examples, as illustrated in FIG. 1, first tube 104 may define a flange 106 at or around the first end of first tube 104. Flange 106 may define a greater outer perimeter and surface area than a cross-section of first tube 104. First tube 104 may be formed from a first material including, but are not limited to, a metal, a metallic alloy, or a ceramic. First tube 104 may define an inner lumen extending along longitudinal axis 102. The inner lumen may be configured to retain a fluid (e.g., a gas) and facilitate movement of the fluid along the longitudinal length of first tube 104.

Second tube 108 may extend along longitudinal axis 102 to a second end at interface 112. In some examples, as illustrated in FIG. 1, second tube 108 may define a flange 107 at or around the second end of second tube 108. Flange 107 may define a greater outer perimeter and surface area than a cross-section of second tube 108. Second tube 108 may be formed from a second material including, but are not limited to, metal, metallic alloy, or a ceramic. The second material of second tube 108 may be the same as or different from the first material of first tube 104. For example, the first material may be a ceramic and the second material may be a metallic alloy. Second tube 108 may define an inner lumen extending along longitudinal axis 102. The inner lumen may be configured to retain a fluid and facilitate movement of the fluid along the longitudinal length of second tube 108.

Each of the first end of the first tube 104 and the second end of the second tube 108 include a smooth, planar surface. The first end of first tube 104 and the second end of second tube 108 are placed into contact at interface 112 to form a substantially hermetic seal. When first tube 104 and second tube 108 are placed into contact at interface 112, the inner lumens of first tube 104 and second tube 108 are fluidically connected such that a fluid may flow from the inner lumen of first tube 104 across interface 112 and into the inner lumen of second tube 108, or vice versa. The substantially hermetic seal at interface 112 may inhibit escape of the fluid from first tube 104 and/or second tube 108 at interface 112. In some examples, flanges 106, 107 may inhibit escape of the fluid at interface 112, e.g., by increase contact area between first tube 104 and second tube 108 and increase a distance the fluid is required to travel from the inner lumens of first tube 104 and second tube 108 and an outer perimeter of interface 112 (e.g., as defined by the outer perimeters of flanges 106, 107).

Fixation mechanism 110 may be disposed around first tube 104 and second tube 108 at or around interface 112. Fixation mechanism 110 may interface with first tube 104 and second tube 108 to cause first tube 104 to contact second tube 108 at interface 112. For example, fixation mechanism 110 may apply relative forces towards interface 112 along or parallel to longitudinal axis 102 (e.g., compressive forces) to cause first tube 104 to contact second tube 108 at interface 112. Fixation mechanism 110 may include two or more split flanges 116A, 116B (collectively referred to herein as “split flanges 116”), each of split flanges 116 being configured to interface with one of first tube 104 or second tube 108. First split flange 116A may be coupled to first tube 104, e.g., to flange 106 of first end 104. Second split flange 116B may be coupled to second tube 108, e.g., to flange 107 of second end 108. Split flanges 116 may be connected via a plurality of elongated bodies 118 extending through split flanges 116. Springs 120 may be disposed around and affixed to elongated bodies 118. Springs 120 may apply spring forces to split flanges 116, e.g., to cause fixation mechanism 110 to apply forces on first tube 104 and second tube 108.

Split flanges 116 may interface with respective flanges 106, 107 to cause flange 106 to contact flange 107 and form a seal at interface 112. Each of split flanges 116 may extend substantially around the entire outer perimeter of the respective tube or flange, e.g., to equally apply forces along the entire outer perimeter of the respective tube or flange. For example, a first split flange 116A may extend around the entire outer perimeter of flange 106 of first tube 104 and a second split flange 116B may extend around the entire outer perimeter of flange 107 of second tube 108. Each of split flanges 116 may define two or more channels, each channel being configured to retain a respective elongated body 118. Each of split flanges 116 may be formed from two or more sub-sections and may be assembled around first tube 104 or second tube 108.

Elongated bodies 118 may extend through and couple split flanges 116. For example, as illustrated in FIG. 1, elongated bodies 118 may be bolts or pins extending through split flanges 116 at opposite sides of interface 112. Elongated bodies 118 may transmit forces from springs 120 affixed to elongated bodies 118 to split flanges 116 to cause first split flange 116A and second split flange 116B to apply forces to first tube 104 and second tube 108, respectively. The forces may bring first tube 104 and second tube 108 into contact at interface 112 and form the seal at interface 112. Fixation mechanism 110 may include two, three, or four or more elongated bodies 118. Elongated bodies 118 may be evenly distributed around the outer perimeter of split flanges 116, e.g., to facilitate an even distribution of force around the outer perimeters of split flanges 116. Split flanges 116 and elongated bodies 118 may evenly apply forces to first tube 104 and second tube 108 to facilitate formation of a substantially uniform seal between first tube 104 and second tube 108 at interface 112. The substantially uniform seal may facilitate retention of the seal throughout thermal cycles and may further inhibit potential escape of gas at interface 112.

Split flanges 116 and elongated bodies 118 may not contact outer perimeters of flanges 106, 107. Thus, when one or more of flanges 106, 107 radially expands or contracts during a thermal cycle, split flanges 116 and elongated bodies 118 may not inhibit such movement. By allowing the radially expansion or contract of flanges 106, 107 during thermal cycles, fixation mechanism 110 may facilitate maintenance of the seal at interface 112 during expansion or contraction of flanges 106, 107.

Springs 120 may be disposed around elongated bodies 118. Springs 120 may be affixed (e.g., removably affixed) to elongated bodies 118. For example, as illustrated in FIG. 1, each of springs 120 may be held captive at one end by one of a split flange 116 (e.g., second split flange 116B) and at an opposite end by a retention mechanism (e.g., a nut) affixed to elongated body 118. Springs 120 may be held in an at least partially compressed configurations in fixation mechanism 120 and may apply a spring force on split flanges 116, e.g., in reaction to the at least partial compression of springs 120). Springs 120 may be uniform (e.g., may define the same longitudinal lengths, outer perimeters, materials, spring constants), to facilitate application of uniform forces around the outer perimeter of interface 112 in response to a uniform amount of compression applied to springs 120. Depending on the characteristics of first tube 104 and second tube 108, springs 120 with different characteristics may be selected to facilitate formation and maintenance of the seal between first tube 104 and second tube 108 at interface 112.

Springs 120 may be disposed along elongated bodies 118 such that one of split flanges 116 is disposed between springs 120 and interface 112 along longitudinal axis 102. For example, as illustrated in FIG. 1, second split flange 116B is disposed between interface 112 and springs 120. Springs 120 may be positioned around a tube configured to be exposed to or maintained at a lower temperature (e.g., second tube 108), e.g., to reduce degradation of the properties of spring 120 (e.g., due to thermal creep) over time resulting from exposure to high temperatures.

During a thermal cycle, flange 106 and/or flange 107 may longitudinally and radially expand or contract. Springs 120 may be configured to exert a force on flanges 106 and 107 that is sufficiently high to maintain contact between flanges 106 and 107 sufficient to seal interface 112 and sufficiently low to permit relative radial movement between flanges 106 and 107. As one or more of flanges 106, 107 longitudinally expand or contract during a thermal cycle, springs 120 may compress or elongate accordingly and cause split flanges 116 to maintain contact with flanges 106, 107. The continuous contact between split flanges 116 and flanges 106, 107 and the forces applied on flanges 106, 107 by split flanges 116 maintains the seal at interface 112.

Fixation mechanism 110 illustrated and described herein may provide several advantages over other fixation devices or methods for forming a seal between two tubes. The use of sub-sections to form split flanges 116, elongated bodies 118, and springs 120 facilitate easier and faster assembly and disassembly of fixation mechanism 110 around the tubes than other fixation devise or methods. For example, fixation mechanism 110 allows for simple and rapid disassembly of fixation mechanism 110 to its components for purposes of adjusting tube assembly 100 and/or replacement of damaged components while tubes 104, 108 remain affixed to other components. The modularity of the components of fixation mechanism 110 may also facilitate deployment of fixation mechanism 110 with lower profiles and/or reduced width than other fixation devices or methods, which may be advantageous when tube assembly 100 is disposed in a relatively confined space. Additionally, the ability of fixation mechanism 110 to enable axial and/or radial expansion and contraction of tubes 104, 108 may improve the ability of fixation mechanism 110 to maintain a substantially hermetic seal at interface 112 during thermal cycles and may reduce wear and/or damage to components of tube assembly 100 in response to such movements.

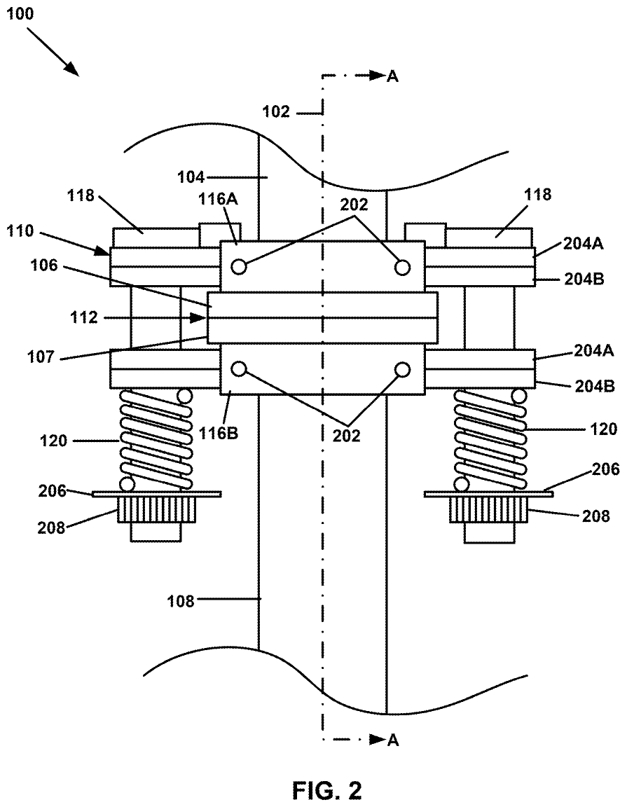

FIG. 2 is a conceptual diagram illustrating a side view of the example tube assembly 100 of FIG. 1. As illustrated in FIG. 2, each of split flanges 116 may be formed from a first sub-section 204A and a second sub-section 204B. Sub-sections 204A, 204B (collectively referred to herein as “sub-sections 204”) may be connected via pins 202.

First sub-section 204A and second sub-section 204B may be connected together around first tube 104 or second tube 108 to form first split flange 116A or second split flange 116B, respectively. First sub-section 204A and second sub-section 204B may be disposed around either of first tube 104 or second tube 108 together and connected via pins 202 without requiring disassembly of first tube 104 or second tube 108 from other components. In some examples, sub-sections 204 may be affixed via one or more other means (e.g., via insertion of elongated bodies 118 through sub-sections 204) instead of or in addition to pins 202. Each of split flanges 116 may be disassembled into sub-sections 204 without requiring separation of first tube 104 and second tube 108 at interface 112 or disassembly of first tube 104 or second tube 108 from other components. Sub-sections 204 may be identical or may be different. For example, second sub-section 204B may be positioned relative to first sub-section 204A such that second sub-section 204B mirrors first sub-section 204A. Second sub-section 204B may then be placed in contact with first sub-section 204A and pins 202 may be inserted through sub-sections 204 to form one of split flanges 116. When sub-sections 204 are affixed together, split flanges sub-sections 204 may be circumferentially and/or longitudinally overlapping.

Sub-sections 204 may, when affixed as one of split flanges 116, define a central opening. The central opening may be sized to receive first tube 104 or second tube 108. For example, an inner diameter of the central opening defined by sub-sections 204 may be greater than or equal to an outer diameter of either first tube 104 or second tube 108. In some examples, where first tube 104 and second tube 108 define uniform outer diameters, sub-sections 204 of first split flange 116A and second split flange 116B may define central openings with uniform inner diameters. In some examples, where first tube 104 and second tube 108 define different outer diameters, sub-sections 204 of first split flange 116A may define a first central opening with a different inner diameter than a second central opening defined by sub-sections 204 of second split flange 116B.

Each of first sub-section 204A and second sub-section 204B may define openings configured to receive elongated bodies 118. For example, each of sub-sections 204A, 204B may define two or more openings, each opening configured to receive a corresponding elongated body 118 of fixation mechanism 110. When assembled, parts of sub-sections 204A, 204B may circumferentially and/or longitudinally overlap to define the openings. Each of openings may define an inner diameter greater than or equal to an outer diameter of a shaft of elongated body 118 but less than or equal to an outer diameter of a head of elongated body 118. In such examples, sub-sections 204 may impede travel of the heads of the elongated bodies 118 through the openings, thereby retaining elongated bodies 118 within fixation mechanism 110. When affixed to first split flange 116, elongated bodies 118 may transfer forces from spring 120 to first split flange 116 via the heads of elongated bodies 118.

Spring 120 may be retained around elongated body 118 via washer 206 and nut 208. Retained spring 120 may be allowed to compress or expand, e.g., in response to expansion or contraction of first tube 104 and/or second tube 108. Washers 206 and nuts 208 may be secured around elongated bodies 118 to control the movement of springs 120 and facilitate application of spring forces by springs 120 on split flanges 116.

Each elongated body 118 may be at least partially threaded, e.g., to facilitate the removable retention of a nut on elongated body 118. Each elongated body 118 may be threaded along its entire longitudinal length or may be threaded along a section at or around an end of elongated body 118. Spring 120 may be disposed between interface 112 and the threaded section of elongated body 118. Elongated bodies 118 may be uniformly threaded, e.g., to facilitate even compression of springs 120 and/or even distribution of forces on split flanges 116.

Nut 208 may be threaded onto elongated body 118 and affixed to elongated body 118. Washer 206 may distribute the forces exerted by springs 120 over a greater surface area and may inhibit loosening of washers 206 in response to the spring forces exerted by springs 120. In other examples, other types of fasteners may be used to retain springs 120 around elongated bodies 118. Nuts 208, washers 206, and/or other fasteners may be removably secured to elongated bodies 118 and may be removed without requiring disassembly of first tube 104 or second tube 108 from other elements. Nuts 208, washers 206, and/or other fasteners may be removed to disassemble fixation mechanism 110, e.g., to adjust fixation mechanism 110, replace components of fixation mechanism 110, or the like. In some examples, other fasteners may include, but is not limited to, a pin configured to be inserted into elongated body 118 to inhibit travel of spring 120.

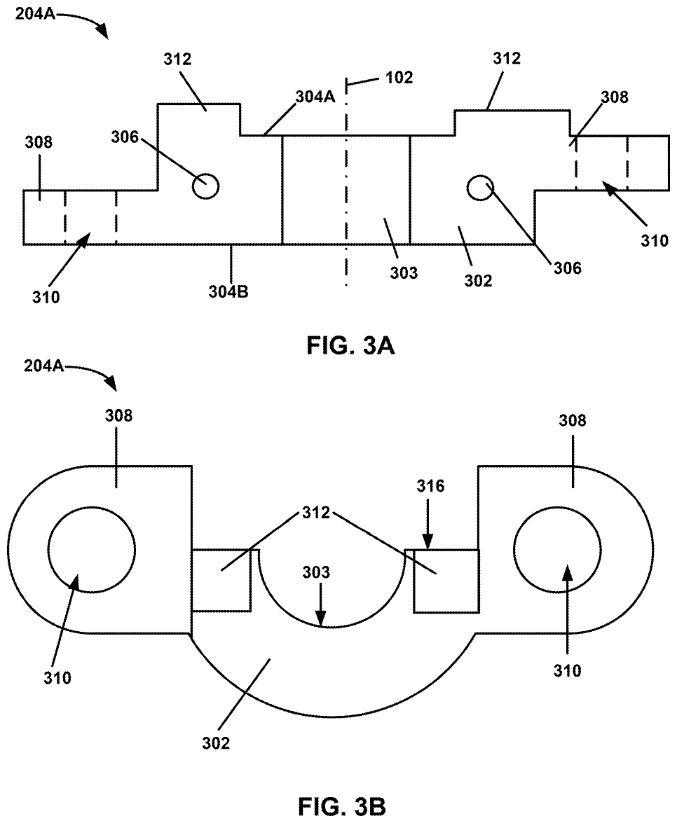

FIG. 3A is a conceptual diagram illustrating a side view of an example sub-section 204A of an example first split flange 116 of the example fixation mechanism 110 of FIG. 2, with some internal features illustrated in broken lines. FIG. 3B is a conceptual diagram illustrating a top view of the example sub-section 204A of FIG. 3A. Sub-section 304A may include a central element 302 and a plurality of extensions 308 extending off of central element 302.

Central element 302 may extend along longitudinal axis 102 from a first surface 304A to a second surface 304B. First surface 304A may be parallel to second surface 304B. Surfaces 304A, 304B may be orthogonal to longitudinal axis 102. Central element 302 may define an inner surface 303. When sub-sections 204 are affixed together to define one of split flanges 116, inner surfaces 303 of sub-sections 204 may define a central opening through the respective split flange 116. Inner surface 303 may define a curvature and may extend from first surface 304A to second surface 304B. Inner surface 303 may define a uniform curvature from first surface 304A to second surface 304B.

Central element 302 may further define an inner surface 316. Inner surface 316 may surround inner surface 303. When two or more sub-sections 204 are affixed together to define a split flange 116, inner surfaces 316 of sub-sections 204 may contact and be placed in apposition, e.g., to form a seal between sub-sections 204. Inner surface 316 may be substantially flat and extend along a reference plane parallel to longitudinal axis 102, e.g., as illustrate in FIGS. 3A and 3B. In some examples, inner surface 316 may define one or more features (e.g., protrusions, grooves, recesses, curvature) that are configured to interface with one or more corresponding features on inner surface 316 of another sub-section 204 when the sub-sections 204 are placed in contact. For example, inner surface 316 of sub-section 204A may define a first set of features that are configured to interface with a second set of features on inner surface 316 of sub-section 204B when inner surface 316 of sub-section 204A is placed in contact with inner surface 316 of sub-section 204B. The features on the different inner surfaces 316 may interface to facilitate alignment and/or fixation of sub-sections 204 to define one of split flanges 116.

Central element 302 may include one or more protrusions 312 extending from one of surfaces 304 of sub-section 204. Each of protrusions 312 may interface with a head of one of elongated bodies 118, e.g., to inhibit unintended rotation of elongated body 118. A surface of each protrusion 312 may be placed in apposition with a corresponding flat surface on the head of elongated body 118 when elongated body 118 is inserted through split flanges 116. The interface may inhibit rotation of elongated body 118, e.g., in response to a rotational force acting on elongated body 118. In such examples, when an assembly system is securing retention mechanisms (e.g., washer 206, nut 208) to elongated body 118, the assembly system does not need to separate control the orientation of elongated body 118 within side flanges 116, which may reduce a number of tools and/or components to install/uninstall the retention mechanisms.

Sub-section 204A may define a plurality of extensions 308 extending from and away from central element 302. Sub-section 204A may have a same number of extensions 308 as a number of elongated bodies 118 of fixation mechanism 110. For example, as illustrated in FIGS. 1-3B, sub-section 204A includes two extensions 308 corresponding to the two elongated bodies 118 of fixation mechanism 110.

Each of extensions 308 may define at least a section of channels 310 extending parallel to longitudinal axis 102 and through split flanges 116. When sub-sections 204 are affixed together, a first set of extensions 308 on sub-section 204A may interface with a second set of extensions 308 on sub-section 204B to define the channels 310 extending through the formed split flange 116. For example, as illustrated in FIGS. 3A and 3B, sub-section 204A may define a first extension 308 that is flush with a first surface 304A of sub-section 204A and a second extension 308 that is flush with second surface 304B of sub-section 304A. Each of extensions 308 of sub-section 204A may extend from a respective first surface 304A or second surface 304B to a midpoint of sub-section 204A along longitudinal axis 102. Sub-section 204B may have extensions 308 with an identical arrangement as sub-section 204A. In such examples, when sub-sections 204A, 204B are affixed together to define split flanges 116, extensions 308 of sub-section 204A may become longitudinally or circumferentially aligned with and may be configured to interface with extensions 308 on sub-section 304B.

When sub-sections 204 are affixed together to define a split flange 116, extensions 308 of different sub-sections 204 may be circumferentially overlapping and longitudinally offset or may be circumferentially offset and longitudinally overlapping to define channels 310. Where extensions 308 of sub-sections 204 are configured to be circumferentially overlapping and longitudinally offset, extensions 308 on each of sub-sections 204 may define a section of one of channels 310. The section may extend parallel to longitudinal axis 102 and through the respective extension 308. The sections of channels 310 defined by extensions 308 may define an inner diameter greater than or equal to an outer diameter of any of elongated bodies 118. The sections of channels 310 defined by extensions 308 of different sub-sections 204 may be longitudinally aligned to define channel 310. In some examples, where extensions 308 of sub-sections 204 are configured to be circumferentially offset and longitudinally overlapping, each of extensions 308 may extend from first surface 304A to second surface 304B and define a curved surface that, when sub-sections 204 are affixed together, may interface with a corresponding surface on a different sub-section 204 to define a channel 310. The sections of channels 310 defined by extensions 308 may define an inner diameter greater than or equal to an outer diameter of any of elongated bodies 118.

Each of sub-sections 204 may include one or more openings 306 extending through central element 302 of the respective sub-section 204. Each of openings 306 may extend through central element 302 from one side of a respective sub-section 204 to an opposite side of the respective sub-section 204. Openings 306 may extend along reference axes orthogonal to longitudinal axis 102. In some examples, where a sub-section 204 includes two or more openings 306, openings 306 may extend substantially parallel or parallel to each other through the sub-section 204. Each of openings 306 may be sized to receive a pin 202. When sub-sections 204 are aligned (e.g., longitudinally aligned) to define split flange 116, corresponding openings 306 on the different sub-sections 204 may be aligned to define openings extending entirely through split flange 116. For each set of aligned openings 306, one of pins 202 may extend through the aligned openings 205 on the different sub-sections 202, e.g., to affix the different sub-sections 204 together. In such examples, pins 202 may be inserted into and/or retracted from the sets of aligned openings 306 via either end of each set of aligned openings 306. In some examples, one opening 306 of one or more sets of aligned openings 306 may define a blind opening (e.g., may extend from surface 316 of central element 302 towards but through an opposite surface of central element 302). In such examples, pins 202 may be inserted into and/or retracted from the sets of aligned openings 306 via a specific opening 306 within each set of openings 306, where the specific opening 306 extends entirely through central element 302 of the respective sub-section 204.

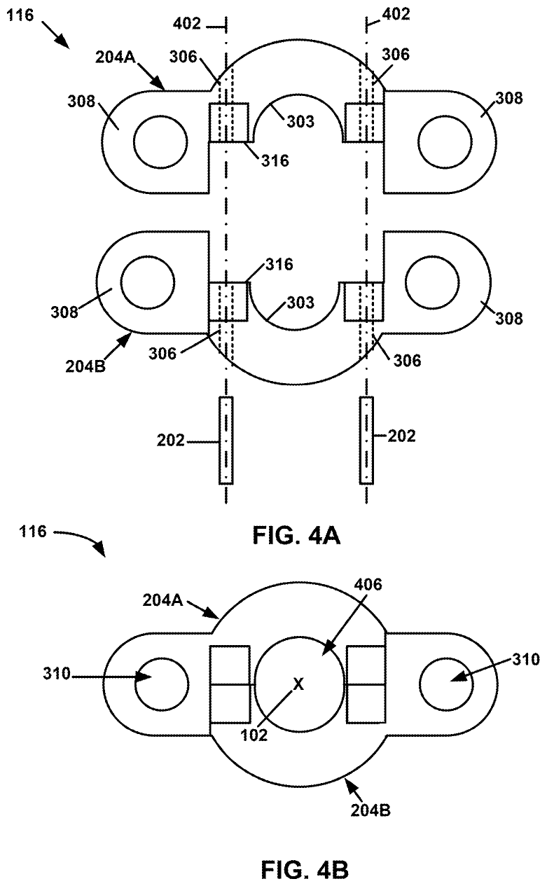

FIG. 4A is a conceptual diagram illustrating an exploded top view of the example split flange 116 of the example fixation mechanism 110 of FIG. 2. FIG. 4B is a conceptual diagram illustrating a top view of the example split flange 116 of the example fixation mechanism 110 of FIG. 2 when assembled. When sub-sections 204A, 204B are aligned, corresponding openings 306 may define reference axes 402. Pins 202 may be inserted into openings 306 along axes 402 to affix sub-section 204A to sub-section 204B. When combined, sub-sections 204A, 204B may define an inner recess 406.

As illustrated in FIG. 4A, when sub-sections 204 are aligned for fixation together as split flange 116, corresponding openings 306 on the respective sub-sections 204 may be aligned along reference axes 402 to define openings extending through the entire length of split flange 116. In such examples, pin 202 may be inserted through sets of openings 306 and into each of sub-sections 204, e.g., to affix sub-sections 204 together. Pin 202 may be inserted into sets of openings 306 through either end of each set of openings 306. For example, as illustrated in FIG. 4A, each of pins 202 may be inserted into a corresponding set of openings 306 from an entrance on an external surface of either sub-section 204A or sub-section 204B. Each of pins 202 may similarly be removed from within a corresponding set of openings 306 through the entrance on the external surface of either sub-section 204A or sub-section 204B.

In some examples, wherein one of openings 306 is a blind opening, the corresponding sets of openings 306 may be aligned along reference axes 402 to define openings extending through one of sub-sections 204 and into another of sub-sections. In such examples, pins 202 may be inserted into and/or removed from a set of openings 306 from an entrance on an external surface of one of sub-sections 204. For example, if sub-section 204A defines openings 306 that are blind (e.g., that do not extend from an inner surface of sub-section 204A to the external surface of sub-section 204A), pins 202 may be inserted into and/or removed from sets of openings 306 via the entrance on the external surface of sub-section 204B.

As illustrated in FIGS. 4A and 4B, when sub-sections 204 are affixed together to define split flange 116, inner surfaces 316 of sub-sections 204 are placed into contact, e.g., to define a seal between sub-sections 204. When the inner surfaces 316 of sub-sections 204 are in apposition, as illustrated in FIG. 4B, inner surfaces 303 may define inner recess 406. Inner recess 406 may extend along longitudinal axis 102 through split flange 116. Inner recess 406 may be sized to retain first tube 104 and/or second tube 108. For example, inner recess 406 may define an inner diameter greater than or equal to an outer diameter of first tube 104 and/or of second tube 108. The inner diameter of inner recess 406 may be less than or equal to an outer diameter of flange 106 and/or of flange 107, e.g., to facilitate retention of split flange 116 around first tube 104 and/or second tube 108 at or around interface 112 and/or to facilitate application of forces by split flange 116 on first tube 104 or second tube 108.

When sub-sections 204 are affixed together to define split flange 116, extensions 308 on each of sub-sections 204 may align to define channels 310 extending through split flange 116. Extensions 308 on sub-sections 204 may circumferentially overlap and sections of channels 310 on the respective extensions 308 may be circumferentially aligned to define channels 310 extending through split flange 116. For example, as illustrated in FIG. 4B, extensions 308 on sub-section 204A may circumferentially overlap with extensions 308 on sub-section 204B to align the sections of channels 310 on the respective extensions 308 and define channels 310 of split flange 116. When sub-sections 204A and 204B are affixed to define split flange 116, extensions 308 on the respective sub-sections 204 may be circumferentially overlapping and longitudinally adjacent, e.g., as illustrated in FIGS. 2, 4A, and 4B.

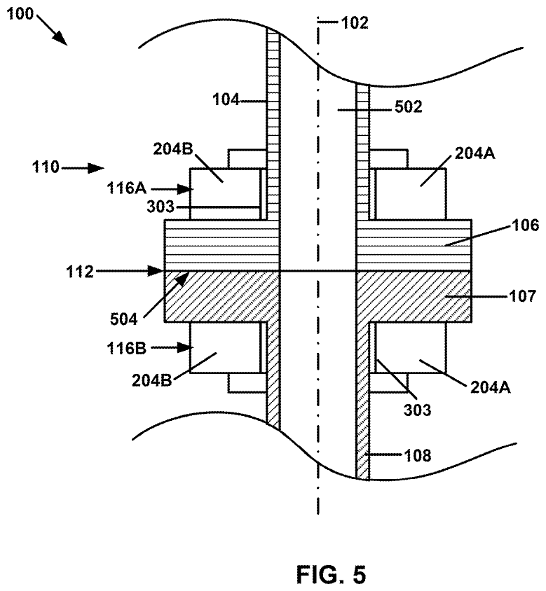

FIG. 5 is a cross-section diagram illustrating a cross-sectional view of the example tube assembly 100 of FIG. 2, the cross-section being taken along line A-A of FIG. 2. As illustrated in FIG. 5, when fixation mechanism 110 causes first tube 104 to contact second tube 108, tubes 104, 108 form a seal 504 at interface 112 and define an inner lumen 502 extending through tubes 104, 108 and across interface 112.

Inner lumen 502 may be defined by inner lumens of first tube 104 and second tube 108 and may extend across interface 112. Inner lumen 502 may be configured to retain a fluid and facilitate travel of the fluid through first tube 104 and second tube 108. At interface 112, the contact between first tube 104 and second tube 108 (e.g., the contact between flanges 106, 107) form a seal 504 at interface 112. Seal 504 may be a hermetic seal. Seal 504 may extend across an entire contact surface area between first tube 104 and second tube 108. In some examples, where first tube 104 and second tube 108 define flanges 106 and 107, as illustrated in FIG. 5, seal 504 extends across an entire contact surface area between flange 106 and flange 107.

Split flanges 116 may apply relative forces on first tube 104 and/or on second tube 108 towards interface 112 to form and maintain seal 504. Split flanges 116 may be defined by two or more sub-sections 204 (e.g., sub-sections 204A, 204B). In such examples, for each of split flanges 116, sub-sections 204 may contact a corresponding tube of first tube 104 or second tube 108 and apply a force on the corresponding tube (e.g., via application of force by one or more of sub-sections 204 on a flange of the corresponding tube). The applied force may be parallel to longitudinal axis 102. In some examples, both of split flanges 116 may apply forces of equal or different magnitudes on tubes 104, 108 at interface 112.

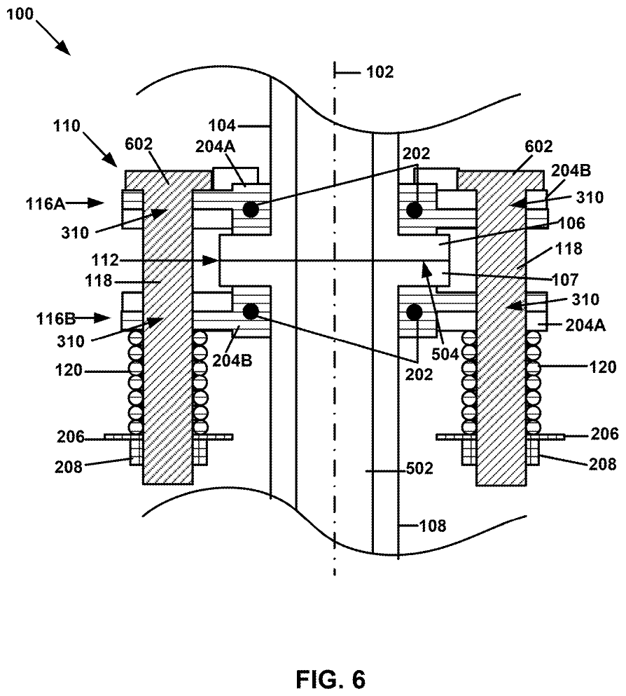

FIG. 6 is a cross-sectional diagram illustrating another cross-sectional view of the example tube assembly 100 of FIG. 2, the cross-section being taken along line A-A of FIG. 2 and along a direction orthogonal to the direction of view illustrated by line A-A.

As illustrated in FIG. 6, fixation mechanism 110 may be disposed around tubes 104, 108 at and/or around interface 112 between tubes 104, 108. For example, first split flange 116A of fixation mechanism 110 may be disposed around first tube 104 and second split flange 116B may be disposed around second tube 108. First split flange 116A may contact first tube 104, e.g., may contact flange 106 of first tube 104. Second split flange 116B may contact second tube 108, e.g., may contact flange 107 of second tube 108.

Elongated bodies 118 of fixation mechanism 110 may extend through split flanges 110 (e.g., through channels 310 within split flanges 116). Elongated bodies 118 may each define a head 602 at one end. Head 602 may define an outer diameter greater than an outer diameter of a remainder of elongated body 118. As illustrated in FIG. 6, head 602 may define an outer diameter greater than an inner diameter of channel 310 of first split flange 116A, thereby inhibiting longitudinal movement of elongated body 118 parallel to longitudinal axis 102 and towards second split flange 116B.

Springs 120 may be disposed around elongated bodies 118 and may be retained via retention mechanisms (e.g., via washer 206 and nut 208). Springs 120 may be positioned around second tube 108 and may be separated from interface 112 by second split flange 116B of fixation mechanism 110. In some examples, where first tube 104 exhibits a higher temperature and/or is configured to be maintained at a higher temperature than second tube 108, springs 120 may be separated from first tube 104 and/or interface 112 by at least second split flange 116B to reduce thermal degradation of spring 120 over time.

Each of springs 120 may contact second split flange 116B, (e.g., may contact one or more sub-sections 204 defining second split flange 116B). Each head 602 of elongated bodies 118 may contact first split flange 116A (e.g., may contact one or more sub-sections 204 defining first split flange 116A). Spring 120 may be maintained in an at least semi-compressed state by the retention mechanisms. For example, a longitudinal distance between second split flange 116B and spring 206 along elongated body 118 may be less than a longitudinal length of spring 120 in an uncompressed state. When spring is in the at least semi-compressed state, spring 120 may apply a spring force on second split flange 116B via the contact between spring 120 and second split flange 116B. Spring 120 may also apply a spring force on first split flange 116A through the contact between heat 602 of elongated body 118 and first split flange 116A. The spring forces applied to split flanges 116 may cause fixation mechanism 110 to apply relative force on tubes 104, 108 towards interface 112 to form and maintain seal 504.

In some examples where fixation mechanism 110 includes two or more springs 120 disposed around two or more elongated bodies 118 (e.g., as illustrated in FIG. 6), springs 120 may apply forces of equal magnitude on first split flange 116A and/or on second split flange 116B. For example, springs 120 may apply forces of equal magnitude at two or more locations around a perimeter of second split flange 116B. Each spring 120 may apply forces on individual split flanges 116 or on both split flanges 116 of between about 13 Newtons (N) to about 89 N (e.g., about 3 pounds-force (lbf) to about 20 lbf).

Springs 120 may be formed from the same materials and may exhibit same or substantially similar characteristics (e.g., spring constants). When fixation mechanism 110 is assembled, springs 120 may be compressed by a same or substantially similar amount, e.g., to facilitate equal application of forces by springs 120. Springs 120 may include, but are not limited to, coil springs, leaf springs, or refractory springs. Springs 120 may be formed from a metallic alloy such as a high-temperature steel alloy (e.g., A286 corrosion resistant stainless steel alloy). Springs 120 may not be formed from materials vulnerable to hydrogen embrittlement (e.g., nickel). In some examples, system 100 may include one or more components with increased compliance in addition to or instead of spring 120. The one or more components may include, but is not limited to, a compliant clip.

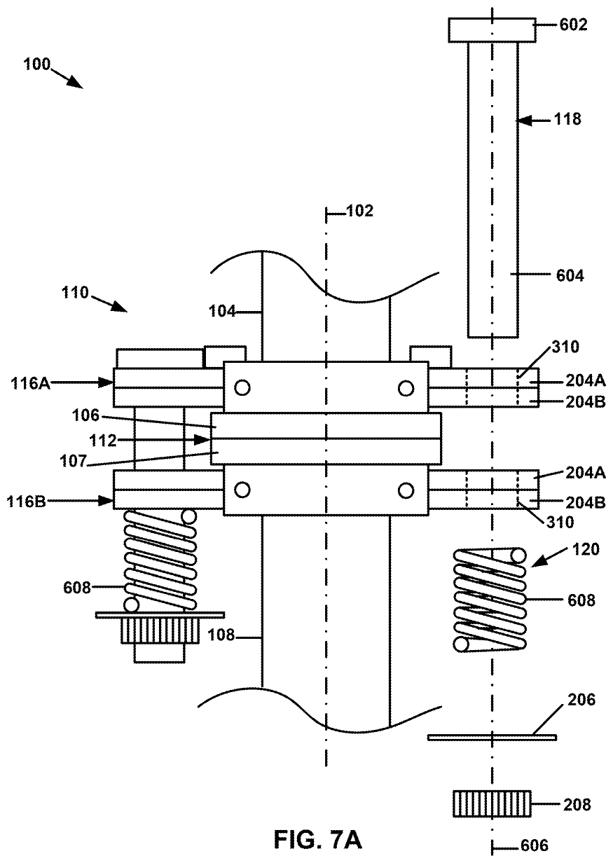

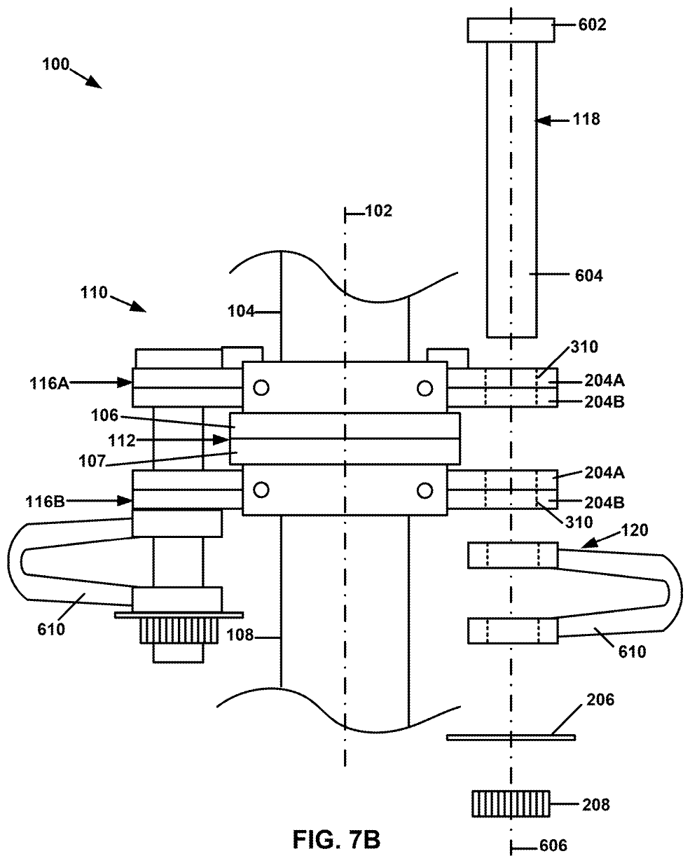

FIG. 7A is a conceptual diagram illustrating an exploded side view of an example elongated body 118 and spring 120 of the example fixation mechanism 110 of FIG. 2. FIG. 7B is a conceptual diagram illustrating an exploded side view of an example elongated body 118 and another example of spring 120 of the example fixation mechanism 110 of FIG. 2. Elongated body 118 may include a head 602 and a body 604 extending from head 602. Each of elongated bodies 118 may be oriented to extend along a reference axis 606 parallel to longitudinal axis 102 within fixation mechanism 110.

Body 604 of elongated body 118 may extend away from head 602 and may define a smaller outer diameter than head 602. The outer diameter of body 604 may be less than or equal to an inner diameter of channels 310 of split flanges 116 of fixation mechanism 110, e.g., to allow for insertion of elongated body 118 into and removal of elongated body 118 from fixation mechanism 110. Head 602 may define an outer diameter greater than the inner diameter of channels 310 to inhibit the full travel of elongated body 118 through fixation mechanism 110 and facilitate retention of elongated body 118 within fixation mechanism 110. For example, as illustrated in FIGS. 7A and 7B, elongated body 118 may be inserted through split flanges 116 via an entrance of channel 310 of first split flange 110A along reference axis 606. For example, elongated body 118 may be inserted through split flanges 116 via a section of channel 310 defined by extension 308 of first sub-section 204A of first split flange 116A.

When elongated body 118 is inserted through channels 310 of split flanges 116 of fixation mechanism 110, head 602 of elongated body 118 may interface with one of split flanges 116 (e.g., first split flange 116A) to inhibit further travel of elongated body 118 towards the other of split flanges 116 (e.g., towards second split flange 116B) along reference axis 606. Elongated body 118 may transmit forces to first split flange 116A (e.g., from spring 120) via the interface between head 602 of elongated body 118 and first split flange 116A, e.g., to maintain seal 504 at interface 112.

Spring 120 may be disposed around body 604 of elongated body 118. Spring 120 may define an inner channel or inner opening sized to retain body 604 of elongated body 118. In some examples, where spring 120 is a coil electrode (e.g., as illustrated in FIG. 7), spring 120 may define an inner channel with an inner diameter greater than or equal to the outer diameter of body 604. Spring 120 may be disposed over a split flange of body 604 extending out of channel 310 of second split flange 116B and away from split flanges 116 of fixation mechanism 110, e.g., to reduce the effects of the thermal energy retained by first tube 104 on spring 120. One end of spring 120 may contact a surface of an extension 308 of one sub-section 204 (e.g., sub-section 204B) of second split flange 116B. When spring 120 is compressed, spring 120 may apply spring force on second split flange 116B. The spring force may cause head 602 of elongated body 118 to apply a corresponding reactive force on first split flange 116A. The forces applied on split flanges 116 may cause fixation mechanism 110 to compress tubes 104, 108 at interface 112, thereby forming seal 504. Spring 120 may be aligned along reference axis 606 such that spring 120 transmits the spring force along reference axis 606 and/or in a direction parallel to reference axis 606. In some examples, as illustrated in FIG. 7A, each spring 120 may be a helical spring 608. In some examples, as illustrated in FIG. 7B, each spring 120 may be a leaf spring 610.

Spring 120 may be retained or held captive around elongated body 118 via one or more retention mechanisms. The retention mechanism(s) may be disposed around body 604 and removably affixed to body 604, e.g., to inhibit unintended removal of spring 120 from around elongated body 118. Retention mechanism(s) may include, but are not limited to, washers 206 and nuts 208. Retention mechanism(s) may interface with features on an outer surface of body 604 (e.g., grooves, recesses) to removably affix retention mechanism(s) to elongated body 118. In some examples, retention mechanism(s) may include features (e.g., self-locking threads) configured to facilitate fixation of retention mechanism(s) to elongated body 118. Nuts 208 may include, but are not limited to, a self-locking nut.

Retention mechanism(s) may be secured at a specific location along the longitudinal length of body 604 to define a set distance between retention mechanism(s) and the closest surface of second split flange 116B. The set distance may be less than an uncompressed longitudinal length of spring 120, e.g., to maintain springs 120 under at least partial compression within fixation mechanism 110. When retention mechanism(s) are secured to elongated body 118 at the specific location, the set distance may change (e.g., may decrease) due to thermal expansion of one or more of tubes 104, 108, which may cause springs 120 to further compress in response. The increased compression of springs 120 may increase the spring force and reactive force applied by spring 120 and head 602 on split flanges 116, which may increase the compressive forces applied by fixation mechanism 110 on tubes 104, 108. The increased compressive force may cause tubes 104, 108 to maintain seal 504 as one or more tubes 104, 108 undergo thermal expansion.

When springs 120 are secured around elongated bodies 118, springs 120 may compress in response to longitudinal movement of one or more of tubes 104, 108 and/or may elastically deform in response to radial movement of one or more of tubes 104, 108. Spring may facilitate movement of split flanges of fixation mechanism 110 in response to radial movement of one or more of tubes 104, 108 and may reduce stress experienced by fixation mechanism 110 due to said motion.

Retention mechanism(s) may be removed from around elongated body 118, e.g., to facilitate disassembly of at least a split flange of fixation mechanism 110. For example, retention mechanism(s) may be removed from around elongated body 118 prior to removal of elongated body 118 or springs 120 from fixation mechanism 110 and/or prior to disassembly of one or more of split flanges 116 of fixation mechanism 110.

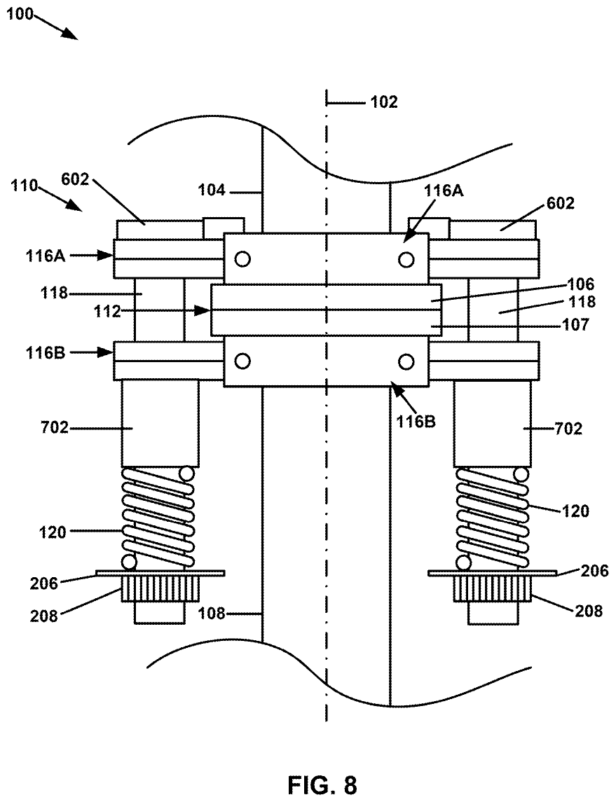

FIG. 8 is a conceptual diagram illustrating a side view of another example of the fixation mechanism 110 of FIG. 2. As illustrated in FIG. 8 fixation mechanism 110 may include a plurality of insulation elements 702, each insulation element 702 being around elongated body 118 and between second split flange 116B and one of springs 120. Insulation elements 702 may insulate springs 120 from thermal energy transmitted by one or more of tubes 104, 108, thereby reducing or inhibiting thermal degradation of springs 120.

Insulation elements 702 may define an annular cylinder defining an inner lumen. The inner lumen of insulation elements 702 may define an inner diameter greater then or equal to an outer diameter of body 604, e.g., to facilitate retention of body 604 within the inner lumen of insulation element 702. The outer diameter of insulation element 702 may be greater than or equal to an inner diameter of channel 310 of second split flange 116B, e.g., to inhibit unintended movement of insulation element 702 into channel 310. Insulation element 702 may be formed from one or more thermally insulating materials, including, but are not limited to, Aluminum Nitride, low thermal conductivity ceramics (e.g., quartz, zirconia, machinable Alumina Silicate L911A (LAVA), machinable ceramic by corning (MACOR)), or low thermal conductivity complex oxides.

When insulation element 702 is disposed around elongated body 118, one end of insulation element 702 may contact a surface of second split flange 116B while an opposite end of insulation element 702 may contact an end of spring 120. Insulation element 702 may thermally insulate spring 120 from second split flange 116B and, by extension, tubes 104, 108. For example, insulation element 702 may limit an amount of thermal energy transferred from second split flange 116B to spring 120 via conduction. Insulation element 702 may be configured to receive spring forces applied by spring 120 (e.g., in response to an at least partial compression of spring 120) and transmit the received spring force or substantially the entire received spring force to second split flange 116B.

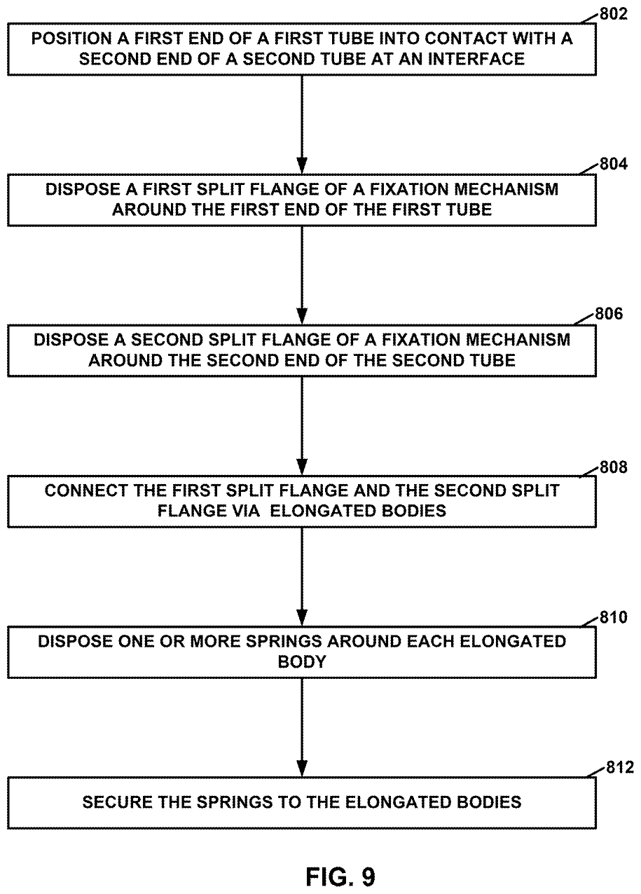

FIG. 9 is a flow chart illustrating an example process of assembling the example tube assembly 100 of FIG. 1. While the example process illustrated in FIG. 9 is described primarily with respect to the example tube assembly 100 of FIG. 1, the example process may be performed to assemble other example tube assemblies with any of the components described herein (e.g., any of the example fixation mechanisms described herein).

A assembly system may position a first end of first tube 104 in contact with a second end of second tube 108 at interface 112 (802). The assembly system may circumferentially align the first end of first tube 104 to the second end of second tube 108 and place the first end into contact with the second end at interface 112. In some examples first tube 104 defines a flange 106 at the first end and second tube 108 defines a flange 107 at the second end. In such examples, flange 106 may be placed in contact with flange 107 at interface 112 to connect tubes 104, 108 at interface 112. When tubes 104, 108 are in contact at interface 112, the inner lumens of tubes 104, 108 may be fluidically connected and may define an inner lumen 502 extending through tubes 104, 108. Inner lumen 502 may facilitate flow of fluids between first tube 104 and second tube 108.

The assembly system may dispose a first split flange 116A of fixation mechanism 110 around the first end of first tube 104 (804). First split flange 116A may be defined by two or sub-sections 204. In some examples, as illustrated in FIGS. 1-8, first split flange 116A may include a first sub-section 204A and a second sub-section 204B. The assembly system may assemble first split flange 116A at a specific location along the longitudinal length of first tube 104, e.g., to place flange 106 of first tube 104 between interface 112 and first split flange 116A. In such examples, first split flange 116A may control movement of the first end of first tube 104 and may apply forces on the first end of first tube 104 (e.g., via flange 106) to form seal 504 between first tube 104 and second tube 108 at interface 112.

The assembly system may dispose one sub-section 204 (e.g., first sub-section 204A, second sub-section 204B) at least partially around first tube 104. For example, the assembly system may dispose the sub-section 204 around first tube 104 such that inner surface 303 defined by sub-section 204 is placed in contact with an outer surface of first tube 104 and/or that inner surface 303 at least partially encircle the outer perimeter of first tube 104.

The assembly system may align one or more other sub-sections 204 to sub-section 204 disposed around first tube 104. The assembly system may longitudinally and/or circumferentially align sub-sections 204. For example, the assembly system may align central elements 302 of sub-sections 204 such that corresponding openings 306 of sub-sections 204 are aligned to define openings. The assembly system may align extensions 308 of sub-sections 204 to align sections of channels 310 defined by extensions 308 to form channels 310 extending through sub-sections 204.

The assembly system may place sub-sections 204 into contact at the proper alignment. In some examples, the assembly system places inner surfaces 316 of central elements 302 of sub-sections 204 into contact. Placing inner surfaces 316 of central elements 302 into contact may cause inner surfaces 303 of sub-sections 204 to encircle the entire outer perimeter of first tube 104 and define inner recess 406 extending through first split flange 116A. The assembly system may place surfaces of corresponding extensions 308 into contact, e.g., to define channels 310 and form a seal extending away from inner recess 406. Once sub-sections 204 are placed into contact, the assembly system may insert pin 202 into each set of aligned openings 306 to affix sub-sections 204 together. Each pin 202 may extend through openings 202 and through two or more sub-sections 204 and may inhibit unintended separation of sub-sections 204. Pins 202 may be removed from within openings 202 (e.g., via one or more entrances to each set of aligned openings 306) to facilitate disassembly and/or reassembly of first split flange 116.

The assembly system may dispose a second split flange 116B of fixation mechanism 110 around the second end of second tube 108 (806). The assembly system may dispose second split flange 116B around the second end of second tube 108 in a same manner as the assembly and disposition of first split flange 116A around the first end of first tube 104. The assembly system may align second split flange 116B relative to first split flange 116A such that a channel 310 within second split flange 116B is circumferentially aligned to a channel 310 within first split flange 116A.

The assembly system may connect the first split flange 116 and the second split flange 116 via elongated bodies 118 (808). The assembly system may insert body 604 of each elongated body 118 through split flanges 116 via channels 310 within split flanges 116. In some examples, where first tube 104 is configured to be maintained at a higher temperature and/or have a lower CTE value than second tube 108, the assembly system inserts elongated body 118 into channel 310 of first split flange 116A, through channel 310 of first split flange 116A, into channel 310 of second split flange 116B, and through channel 310 of second split flange 116B. In some examples, where first tube 108 is configured to be maintained at a lower temperature and/or have a higher CTE value than second tube 104, the assembly system inserts elongated body 118 into channel 310 of second split flange 116B, through channel 310 of second split flange 116B, into channel 310 of first split flange 116A, and through channel 310 of first split flange 116A.

Elongated body 118 may include head 602 connected to body 604. Head 602 may define an outer diameter greater than an outer diameter of body 604. When the assembly system inserts elongated body 118 into channels 310, head 602 may interface with a surface of first split flange 116A to inhibit travel of the entirety of elongated body 118 through channels 310 of split flanges 116.

The assembly system may dispose one or more springs 120 around each elongated body 118 (810). The assembly system may advance one or more springs 120 over body 604 of elongated body 118 from a free end of elongated body 118 (e.g., an end of body 604 opposite of head 602). Each spring 120 may define a recess or channel sized to receive body 604. The assembly system may advance one or more springs 120 along body 604 of elongated body 118 until one end of one of one or more springs 120 contacts a surface of second split flange 116B.

The assembly system may secure springs 120 to the elongated bodies 118 (812). The assembly system may removably affix one or more retention mechanisms to each elongated body 118 to removably retain one or more springs 120 around elongated body 118. Retention mechanisms may include, but are not limited to, washers 206 and nuts 208. The assembly system may affix the one or more retention mechanisms along body 604 at a specific location. The specific location may be a set distance away from the surface of second split flange 116B. The set distance may be less than an un-compressed longitudinal length of one of springs 120 or a maximum length between one end of the one or more springs 120 and an opposing end of the one or more springs 120 along elongated body 118 when each of the one or more springs 120 is in an uncompressed state. Thus, when retention mechanisms are affixed to elongated bodies 118, the retention mechanisms may maintain springs 120 in at least partially compressed states.

When assembled, tube assembly 100 may include fixation mechanism 110 disposed around tubes 104, 108 at or around interface 112, Fixation mechanism 110 may continue to apply relative forces on tubes 104, 108 towards interface 112 to form and maintain a hermetic seal (e.g., seal 504) between tubes 104, 108 at interface 112. Fixation mechanism 110 may apply relative forces on tubes 104, 108 via compression of springs 120. Springs 120 may be maintained in an at least partially compressed state and apply relative forces (e.g., spring forces, reactive forces) on tubes 104, 108 towards interface 112 along longitudinal axis 102.

The example process illustrated in FIG. 9 and described above includes one non-limiting example process of assembling tube assembly 100. In other examples, other example processes may be used and/or other orderings of the steps illustrated in FIG. 9 may be used to assemble tube assembly 100. In some examples, the assembly system may perform the steps of the example process illustrated in FIG. 9 in reverse to disassemble at least a split flange of tube assembly 100 (e.g., at least fixation mechanism 110).

The following examples illustrate example subject matter described herein.

Example 1: an assembly comprising: a first tube defining a first surface at a first end of the first tube; a second tube defining a second surface at a second end of the second tube, wherein the second surface of the second tube is configured to contact the first surface of the first tube at an interface, and wherein the first tube and the second tube define different coefficients of thermal expansion (CTE); a fixation mechanism configured to be disposed around the first tube and the second tube at the interface, the fixation mechanism comprising: a first split flange disposed around the first tube; a second split flange disposed around the second tube; and one or more springs coupled to the first split flange and the second split flange, wherein the first tube and the second tube define a longitudinal axis extending through the interface, wherein the one or more springs are configured to transfer a relative force between the first tube and the second tube and towards the interface, and wherein the second split flange is configured to be disposed longitudinally between the interface and the one or more springs.

Example 2: the assembly of example 1, wherein the fixation mechanism further comprises one or more elongated bodies, each elongated body of the one or more elongated bodies being configured to extend through the first split flange and the second split flange, wherein each spring of the one or more springs is configured to be disposed around a respective elongated body of the one or more elongated bodies.

Example 3: the assembly of example 2, wherein each of the first split flange or the second split flange defines: a first channel configured to retain the first tube or the second tube; and one or more second channels, each second channel of the one or more second channels being configured to retain a respective elongated body of the one or more elongated bodies.

Example 4: the assembly of example 3, wherein each of the first split flange and the second split flange comprises two or more sub-sections, wherein when the two or more sub-sections are affixed together, the two or more sub-sections define the respective first split flange or the second split flange, and wherein each sub-section of the two or more sub-sections at least partially defines the first channel and at least one second channel of the one or more second channels.

Example 5: the assembly of any of examples 1-4, wherein the first end of the first tube includes a first flange, the first flange defining the first surface, wherein the second end of the second tube includes a second flange, the second flange defining the second surface, and wherein the first flange is configured to contact the second flange at the interface.

Example 6: the assembly of any of examples 1-5, wherein the fixation mechanism comprises one or more insulation elements, each of the one or more insulation elements being disposed longitudinally between the second split flange and a respective spring of the one or more springs.

Example 7: the assembly of any of examples 1-6, wherein the fixation mechanism is configured to cause the first surface and the second surface to evenly transmit the force across a contact surface between the first surface and the second surface at the interface.

Example 8: the assembly of any of examples 1-7, wherein each spring of the one or more springs comprises a helical spring or a leaf spring.

Example 9: the assembly of any of examples 1-8, wherein the first tube comprises a ceramic material, and wherein the second tube comprises a metallic material.

Example 10: the assembly of any of examples 1-9, wherein the fixation mechanism allows for movement of one or more of the first tube or the second tube along a reference plane orthogonal to the longitudinal axis of the assembly.

Example 11: a method comprising: placing a first surface at a first end of a first tube into contact with a second surface at a second end of a second tube at an interface, wherein the first tube and the second tube define different coefficients of thermal expansion (CTE), and wherein when the first surface contacts the second surface, the first tube and the second tube define a longitudinal axis extending through the interface; affixing a first split flange of a fixation mechanism around the first tube at or around the interface; affixing a second split flange of the fixation mechanism around the second tube at or around the interface; advancing one or more elongated bodies through the first split flange and the second split flange to connect the first split flange to the second split flange; and disposing one or more springs over the one or more elongated bodies, wherein the second split flange is longitudinally between the interface and the one or more springs, and wherein the one or more springs are configured to transfer a relative force between the first tube and the second tube and towards the interface.

Example 12: the method of example 11, wherein affixing the first split flange of the fixation mechanism around the first tube comprises: disposing two or more sub-elements of the first split flange around an outer perimeter of the first tube; and affixing the two or more sub-elements together to form the first split flange, wherein when the two or more sub-elements are affixed, the two or more sub-elements define one or more channels extending through the first split flange, and wherein each channel of the one or more channels is configured to receive a respective elongated body of the one or more elongated bodies.

Example 13: the method of any of examples 11 or 12, further comprising: disposing one or more insulation elements over the one or more elongated bodies; and disposing the one or more springs over the one or more elongated bodies after the one or more insulation elements are disposed over the one or more elongated bodies, wherein the second split flange is disposed longitudinally between the interface and the one or more insulation elements, and wherein the one or more insulation elements are disposed longitudinally between the second split flange and the one or more springs.

Example 14: the method of any of examples 11-13, wherein the fixation mechanism is configured to cause the first surface and the second surface to evenly transmit the force across a contact surface between the first surface and the second surface at the interface.

Example 15: the method of any of examples 11-14, wherein each spring of the one or more springs comprises a helical spring or a leaf spring.

Example 16: the method of any of examples 11-15, wherein the first tube comprises a ceramic material, and wherein the second tube comprises a metallic material.

Example 17: the method of any of examples 11-16, wherein the fixation mechanism allows for movement of one or more of the first tube or the second tube along a reference plane orthogonal to the longitudinal axis.

Example 18: a fixation mechanism comprising: a first split flange configured to be disposed around a first end of a first tube at or around an interface between the first tube and a second tube; a second split flange configured to be disposed around a second end of the second tube at or around the interface, wherein the second end of the second tube contacts the first end of the first tube at the interface; two or more elongated bodies extending through the first split flange and the second split flange parallel to a longitudinal axis of the fixation mechanism, wherein the two or more elongated bodies are configured to connect the first split flange to the second split flange, and two or more springs, each spring of the two or more springs being disposed around a respective elongated body of the two or more elongated bodies, wherein the two or more springs are configured to transfer a relative force between the first tube and the second tube and towards the interface, wherein the second split flange is configured to be disposed longitudinally between the first split flange and the two or more springs, and wherein the first tube and the second tube define different coefficients of thermal expansion (CTE).

Example 19: the fixation mechanism of example 18, wherein the fixation mechanism is configured to cause the first end and the second end to evenly transmit the force across a contact surface between the first tube and the second tube at the interface.

Example 20: the fixation mechanism of any of examples 18 or 19, wherein the fixation mechanism is configured to permit movement of one or more of the first tube or the second tube along a reference plane orthogonal to the longitudinal axis.

Example 21: the fixation mechanism of any of examples 18-20, wherein each of the first split flange or the second split flange defines: a first channel configured to retain the first tube or the second tube; and two or more second channels, each second channel of the two or more second channels being configured to retain a respective elongated body of the two or more elongated bodies.

Example 22: the fixation mechanism of example 21, wherein each of the first split flange and the second split flange comprises two or more sub-sections, wherein when the two or more sub-sections are affixed together, the two or more sub-sections define the respective first split flange or the second split flange, and wherein each sub-section of the two or more sub-sections at least partially defines the first channel and at least one second channel of the two or more second channels.

Example 23: the fixation mechanism of any or examples 18-22, further comprising two or more insulation elements, each of the two or more insulation elements being disposed longitudinally between the second split flange and a respective spring of the two or more springs.

Example 24: the fixation mechanism of any of examples 18-23, wherein each spring of the two or more springs comprises a helical spring or a leaf spring.

Various illustrative aspects of the disclosure are described above. These and other aspects are within the scope of the following claims.

What is claimed is:

1. An assembly comprising:
a first tube defining a first surface at a first end of the first tube;
a second tube defining a second surface at a second end of the second tube, wherein the second surface of the second tube is configured to contact the first surface of the first tube at an interface, and wherein the first tube and the second tube define different coefficients of thermal expansion (CTE);
a fixation mechanism configured to be disposed around the first tube and the second tube at the interface, the fixation mechanism comprising:
a first split flange disposed around the first tube;
a second split flange disposed around the second tube; and
one or more springs coupled to the first split flange and the second split flange,
wherein the first tube and the second tube define a longitudinal axis extending through the interface,
wherein the one or more springs are configured to transfer a relative force between the first tube and the second tube and towards the interface, and
wherein the second split flange is configured to be disposed longitudinally between the interface and the one or more springs.

2. The assembly of claim 1, wherein the fixation mechanism further comprises one or more elongated bodies, each elongated body of the one or more elongated bodies being configured to extend through the first split flange and the second split flange, wherein each spring of the one or more springs is configured to be disposed around a respective elongated body of the one or more elongated bodies.

3. The assembly of claim 2, wherein each of the first split flange or the second split flange defines:
a first channel configured to retain the first tube or the second tube; and
one or more second channels, each second channel of the one or more second channels being configured to retain a respective elongated body of the one or more elongated bodies.

4. The assembly of claim 3, wherein each of the first split flange and the second split flange comprises two or more sub-sections, wherein when the two or more sub-sections are affixed together, the two or more sub-sections define the respective first split flange or the second split flange, and wherein each sub-section of the two or more sub-sections at least partially defines the first channel and at least one second channel of the one or more second channels.

5. The assembly of claim 1,
wherein the first end of the first tube includes a first flange, the first flange defining the first surface,
wherein the second end of the second tube includes a second flange, the second flange defining the second surface, and
wherein the first flange is configured to contact the second flange at the interface.

6. The assembly of claim 1, wherein the fixation mechanism comprises one or more insulation elements, each of the one or more insulation elements being disposed longitudinally between the second split flange and a respective spring of the one or more springs.

7. The assembly of claim 1, wherein the fixation mechanism is configured to cause the first surface and the second surface to evenly transmit the force across a contact surface between the first surface and the second surface at the interface.

8. The assembly of claim 1, wherein each spring of the one or more springs comprises a helical spring or a leaf spring.

9. The assembly of claim 1, wherein the first tube comprises a ceramic material, and wherein the second tube comprises a metallic material.

10. The assembly of claim 1, wherein the fixation mechanism allows for movement of one or more of the first tube or the second tube along a reference plane orthogonal to the longitudinal axis of the assembly.

11. A method comprising:
placing a first surface at a first end of a first tube into contact with a second surface at a second end of a second tube at an interface,
wherein the first tube and the second tube define different coefficients of thermal expansion (CTE), and
wherein when the first surface contacts the second surface, the first tube and the second tube define a longitudinal axis extending through the interface;
affixing a first split flange of a fixation mechanism around the first tube at or around the interface;
affixing a second split flange of the fixation mechanism around the second tube at or around the interface;
advancing one or more elongated bodies through the first split flange and the second split flange to connect the first split flange to the second split flange; and
disposing one or more springs over the one or more elongated bodies, wherein the second split flange is longitudinally between the interface and the one or more springs, and wherein the one or more springs are configured to transfer a relative force between the first tube and the second tube and towards the interface.

12. The method of claim 11,
wherein affixing the first split flange of the fixation mechanism around the first tube comprises:
disposing two or more sub-elements of the first split flange around an outer perimeter of the first tube; and
affixing the two or more sub-elements together to form the first split flange,
wherein when the two or more sub-elements are affixed, the two or more sub-elements define one or more channels extending through the first split flange, and
wherein each channel of the one or more channels is configured to receive a respective elongated body of the one or more elongated bodies.

13. The method of claim 11, further comprising:
disposing one or more insulation elements over the one or more elongated bodies; and
disposing the one or more springs over the one or more elongated bodies after the one or more insulation elements are disposed over the one or more elongated bodies,
wherein the second split flange is disposed longitudinally between the interface and the one or more insulation elements, and
wherein the one or more insulation elements are disposed longitudinally between the second split flange and the one or more springs.

14. The method of claim 11, wherein the fixation mechanism is configured to cause the first surface and the second surface to evenly transmit the force across a contact surface between the first surface and the second surface at the interface.

15. The method of claim 11, wherein each spring of the one or more springs comprises a helical spring or a leaf spring.

16. The method of claim 11, wherein the first tube comprises a ceramic material, and wherein the second tube comprises a metallic material.

17. The method of claim 11, wherein the fixation mechanism allows for movement of one or more of the first tube or the second tube along a reference plane orthogonal to the longitudinal axis.

18. A fixation mechanism comprising:
a first split flange configured to be disposed around a first end of a first tube at or around an interface between the first tube and a second tube;
a second split flange configured to be disposed around a second end of the second tube at or around the interface, wherein the second end of the second tube contacts the first end of the first tube at the interface;
two or more elongated bodies extending through the first split flange and the second split flange parallel to a longitudinal axis of the fixation mechanism, wherein the two or more elongated bodies are configured to connect the first split flange to the second split flange, and
two or more springs, each spring of the two or more springs being disposed around a respective elongated body of the two or more elongated bodies, wherein the two or more springs are configured to transfer a relative force between the first tube and the second tube and towards the interface,
wherein the second split flange is configured to be disposed longitudinally between the first split flange and the two or more springs, and
wherein the first tube and the second tube define different coefficients of thermal expansion (CTE).

19. The fixation mechanism of claim 18, wherein the fixation mechanism is configured to cause the first end and the second end to evenly transmit the force across a contact surface between the first tube and the second tube at the interface.

20. The fixation mechanism of claim 18, wherein the fixation mechanism is configured to permit movement of one or more of the first tube or the second tube along a reference plane orthogonal to the longitudinal axis.
